(19) United States
(12) Patent Application Publication
(10) Pub. No.: US 2013/0220235 A1
(43) Pub. Date: Aug. 29, 2013

(54) PET MAT

(71) Applicant: Shane T. Wisdom, St. Peters, MO (US)

(72) Inventor: Shane T. Wisdom, St. Peters, MO (US)

(73) Assignee: SHANE T. WISDOM, St. Peters, MO (US)

(21) Appl. No.: 13/406,245

(22) Filed: Feb. 27, 2012

(51) Int. Cl. A01K 15/02; A01K 29/00

(52) U.S. Cl. 119/719

(57) ABSTRACT

A mat system is provided for a pet. The mat system includes a mat having a pet side. The mat is configured to be positioned on a ground surface such that the pet side of the mat is exposed for receiving at least a portion of a pet thereon. The mat includes a pressure-sensing switch configured to be activated when the pet applies a predetermined amount of pressure to the mat. The mat system also includes an input module configured to accept an input from a person, and a playback module operatively connected to the input module and operatively connected to the pressure-sensing switch. The playback module is configured to play audio that represents the input. The playback module is configured to play the audio that represents the input upon activation of the pressure-sensing switch.

### BACKGROUND OF THE INVENTION

The subject matter described and/or illustrated herein relates generally to a mat system for a pet.

More and more pets are living comfortably inside the dwelling of the pet's owner. For example, many pets remain inside a pet owner's dwelling during the majority of the time that the pet owner is home. As with any animal, pets need to relieve themselves and may need to go outside the dwelling to do so. But, it may be difficult to know when the pet wants to exit the dwelling to relieve themselves, which may result in an accident when the pet owner does not let the pet outside the dwelling in time. Moreover, when the pet is outside the dwelling, it may be difficult to know when the pet wants to come back inside. Accordingly, a pet owner may leave the pet outside in inclement or bad weather, which may cause injury and/or discomfort to the pet.

### BRIEF DESCRIPTION OF THE INVENTION

In one embodiment, a mat system is provided for a pet. The mat system includes a mat having a pet side. The mat is configured to be positioned on a ground surface such that the pet side of the mat is exposed for receiving at least a portion of a pet thereon. The mat includes a pressure-sensing switch configured to be activated when the pet applies a predetermined amount of pressure to the mat. The mat system also includes an input module configured to accept an input from a person, and a playback module operatively connected to the input module and operatively connected to the pressure-sensing switch. The playback module is configured to play audio that represents the input. The playback module is configured to play the audio that represents the input upon activation of the pressure-sensing switch.

In another embodiment, a method is provided for enabling a pet to at least one of enter or exit an enclosure through a barrier. The method includes positioning a mat on a ground surface such that a pet side of the mat is exposed for receiving at least a portion of a pet thereon. The method also includes playing a message as audio when the pet applies a predetermined amount of pressure to the mat, and opening the barrier to the enclosure in response to the audio to enable the pet to enter or exit the enclosure.

### BRIEF DESCRIPTION OF THE DRAWINGS

FIG. 1 is a perspective view of an exemplary embodiment of a mat system.

FIG. 2 is a block diagram of the mat system shown in FIG. 1.

FIG. 3 is a flowchart illustrating an exemplary embodiment of a method of using the mat system shown in FIGS. 1 and 2.

### DETAILED DESCRIPTION OF THE INVENTION

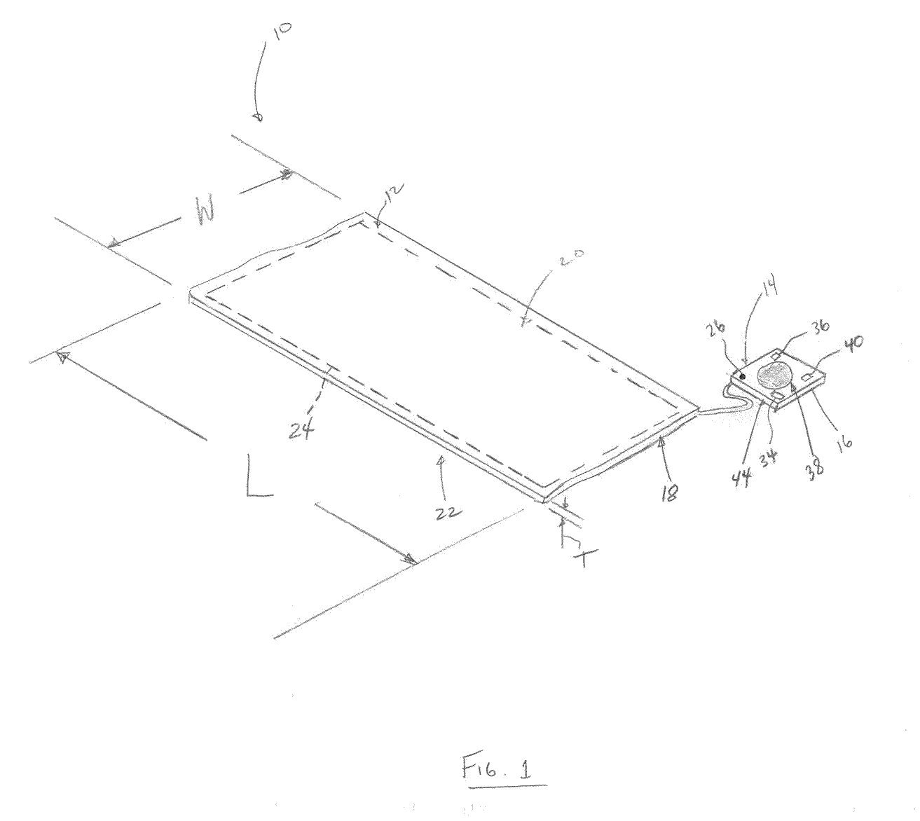

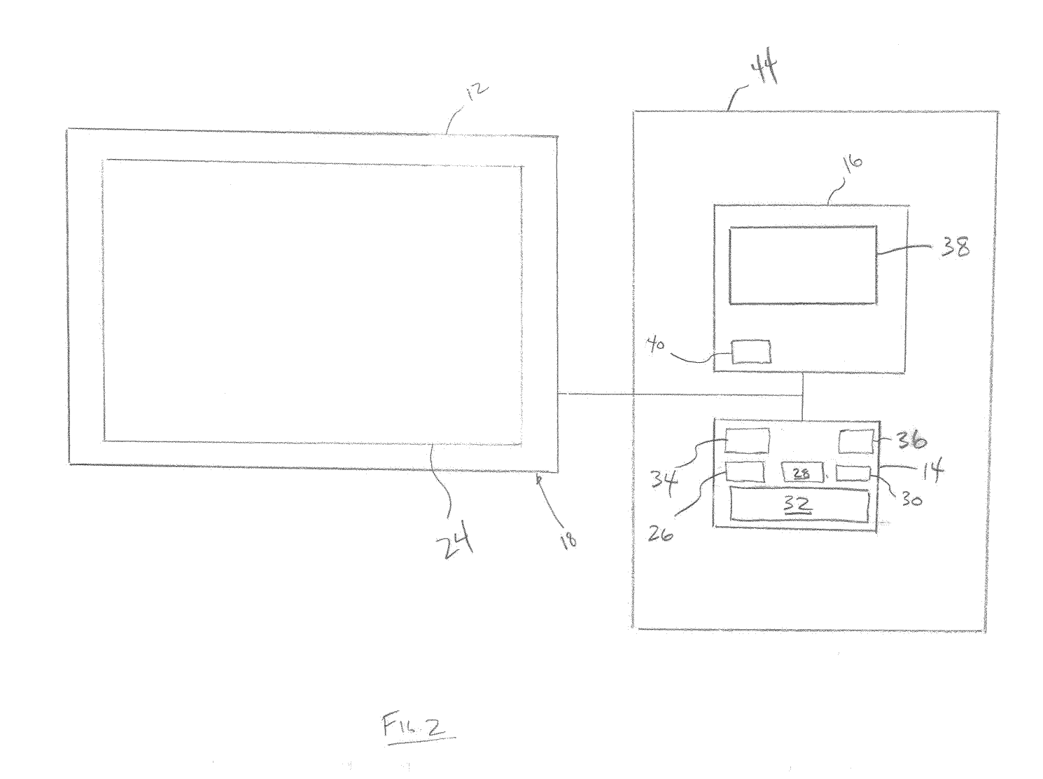

FIG. 1 is a perspective view of an exemplary embodiment of mat system 10. FIG. 2 is a block diagram of the mat system 10. Referring now to FIGS. 1 and 2, the exemplary embodiment of the mat system 10 includes a mat 12, an input module 14, and a playback module 16. As will be described below, the mat system 10 may be used to enable a pet or other individual to enter and/or exit an enclosure (not shown) through a barrier (not shown). For example, the mat system 10 may be used to enable the pet to enter or exit a dwelling through a door. Specifically, when the pet applies pressure to the mat 12, for example by standing or lying on the mat 12, the playback module 16 of the mat system 10 plays an audio message that indicates that the pet desires to enter or exit the enclosure through the barrier. The input module 10 enables a person to select the audio message. For example, the input module 10 may enable the person to record the audio message in the person's own voice. In response to hearing playback of the audio message, a person or other individual can open the barrier to the enclosure to enable the pet to enter or exit the enclosure through the barrier.

The mat 12 includes a body 18 having opposite sides 20 and 22. The side 22 of the mat 12 is configured to be placed on a ground surface such that the side 20 is exposed. The side 20 is configured to receive at least a portion of the pet thereon. For example, the pet may stand on the side 20 of the mat 12 with one or more of the pet's legs, arms, tail, head, nose, and/or other appendages; the pet may lie the pet's torso, core, and/or the like on the side 20; and/or the pet may poke, grab, and/or otherwise engage the side 20 with one or more of the pet's legs, arms, tail, head, nose, and/or other appendages. The side 20 of the mat 12 may be referred to herein as a “pet side”.

In the exemplary embodiment, the approximate entirety of the body 18 of the mat 12 has a relatively sturdy construction, for example a construction that is substantially similar to a wide variety of traditional door mats. But, an approximate entirety of the body 18 may have a relatively soft and/or compliant construction, for example a construction that is substantially similar to a wide variety of traditional pet beds. In other embodiments, the body 18 may include a combination of a relatively sturdy construction and a relatively soft and/or compliant construction. For example, in some embodiments, the body 18 of the mat 12 has a relatively sturdy construction along the side 22 and a relatively soft and/or compliant construction along the side 20. Another example of a combination construction includes a construction wherein only one or more portions of the surface of the side 20 have a relatively soft and/or compliant construction. Providing a soft and/or compliant surface along one or more portions of the side 20 may provide a more comfortable surface for the pet to stand on, lie on, and/or otherwise engage.

The body 18 of the mat 12 may be formed and/or otherwise fabricated from any material(s) that enable the mat 12 to function as described and/or illustrated herein. In the exemplary embodiment, the body 18 has a rectangular shape. But, the body 18 of the mat 12 may have any other shape that enables the mat 12 to function as described and/or illustrated herein. The mat body 18 may have any size that enables the mat 12 to function as described and/or illustrated herein. The thickness T of the body 18 may be selected to provide the amount of softness and/or compliance of the body 18. As used herein, the phrase “ground surface” is intended to mean any surface that enables the mat 12 to function as described and/or illustrated herein, whether such surface is within or exterior to the enclosure.

The mat 12 includes a pressure-sensing switch 24 configured to be activated when the pet applies a predetermined amount of pressure to the mat 12. By “activated”, it is meant that the pressure-sensing switch 24 indicates in any manner that the predetermined amount of pressure has been applied to the mat 12. The value of the predetermined amount of pressure may be any value, which may depend on the particular type of pet with which the mat 12 is intended to be used. For example, the value of the predetermined amount of pressure may be based on a size and/or weight of a particular type of pet (e.g., a weight threshold of a particular type of pet). The weight threshold may be used to determine between different types of pets. For example, a pet owner may desire that the pressure-sensing switch 24 is activated when a dog applies pressure to the mat 12 but not when a cat applies pressure to the mat 12. In some embodiments, the value of the predetermined amount of pressure is selectable by a person, for example from a range of the value and/or using the input module 14. Selection of the value of the predetermined amount of pressure may enable a person to select a weight threshold of the person's specific pet. The pet may apply the predetermined pressure to the mat 12 in any manner, for example by standing on the side 20 of the mat 12 with one or more of the pet's legs, arms, tail, head, nose, and/or other appendages; by lying on the side 20 of the mat 12 with the pet's torso, core, and/or the like; and/or by poking, grabbing, and/or otherwise engaging the side 20 with one or more of the pet's legs, arms, tail, head, nose, and/or other appendages.

The pressure-sensing switch 24 may be any type of switch that enables the pressure-sensing switch 24 to function as described and/or illustrated herein. For example, the pressure-sensing switch 24 may be, but is not limited to being, a mechanical switch, an electromechanical switch, an electronic switch, a digital active device, a toggle switch, a relay, a trembler switch, a transistor, a logic gate, a normally-open switch, a normally-closed switch, and/or the like. As can be seen in FIG. 1, in the exemplary embodiment, the pressure-sensing switch 24 extends along a majority of the length L and width W of the mat body 18. But, the pressure-sensing switch 24 may extend along any amount of the length L and/or width W of the body 18 of the mat 12 that enables the pressure-sensing switch 24 to sense whether the predetermined amount of pressure has been applied to the body 18 of the mat 12. In some embodiments, the pressure-sensing switch 24 extends along only a minority of the length L and/or width W of the body 18. Moreover, in some embodiments, the mat 12 includes a plurality of pressure-sensing switches 24 spread out at different locations along the length L and/or width W of the mat body 18. As indicated in FIG. 1, in the exemplary embodiment, the pressure-sensing switch 24 is positioned within an interior of the body 18 of the mat 12. But, one or more pressure-sensing switches 24 may alternatively be positioned on an exterior surface of the body 18.

Referring now solely to FIG. 2, the input module 14 of the mat system 10 is configured to accept an input from a person. The input enables a person to select an audio message that will be played by the playback module 16 upon activation of the pressure-sensing switch 24. In the exemplary embodiment, the input module 14 includes a microphone 26 and a recording unit 28. Optionally, the mat system 10 includes a memory 30 and/or a processor 32. In the exemplary embodiment, the input module 14 includes the memory 30 and the processor 32. The memory 30 may be used to, for example, store one or more audio messages. The processor 32 may be used to provide processing functionality for some or all of the functions of the input module 14 and/or other components of the mat system 10. The mat system 10 may include a power switch 34 for energizing and de-energizing the electrical components of the mat system 10. In the exemplary embodiment, the input module 14 includes the power switch 34.

The microphone 26 is configured to receive, or accept, the input from a person as audio that is spoken by the person. In other words, in the exemplary embodiment, a person selects the audio message by speaking the audio message into the microphone 26. The recording unit 28 is configured to record the audio spoken by the person for playback by the playback module 16. Accordingly, in the exemplary embodiment, the audio message is a recording of a person's own voice. A microphone activation switch 36 may be provided by the input module 14 for activating the microphone 26 to receive the audio spoken by the person.

In addition or alternatively to the microphone 26 and/or recording unit 28, the input module 14 may include other components for receiving different types of inputs from a person in addition or alternatively to audio that is spoken by the person. For example, the input module 14 may include, but is not limited to including, a keyboard, a mouse, a track pad, a stylus, a pointer, a touch screen, a rotary knob, and/or the like. In some embodiments, the input module 14 may enable a person to compose the input, select the input from a menu, and/or select the input from a list of at least two inputs. In other words, the input module 14 may enable a person to compose the audio message, select the audio message from a menu, and/or select the audio message from a list of at least two audio messages. In such embodiments, the playback module 16 may playback the selected audio message using a computer voice, using pre-recorded audio (e.g., a person's voice recorded during manufacture of the mat system 10, a pre-recording of a user of the mat system 10, an animal noise, a mechanical noise, another type of sound), and/or the like. Moreover, in such embodiments, the mat system 10 may include the memory 30 for storing a menu of audio messages, a list of audio message, an audio message that has been composed by a user of the mat system 10, and/or the like.

In the exemplary embodiment, the microphone 28 is a discrete component of the mat system 10 from a speaker 38 of the playback module 16. But, the speaker 38 may alternatively be used as the microphone 28. The recording unit 28 may include any structure, component, device, and/or the like that enables the recording unit 28 to record audio spoken by a person, such as, but not limited to, an analog recording device, a digital recording device, an electronic memory, a tape drive, a compact disc drive, an MP3 recording device, and/or the like. In some embodiments, the recording unit 28 and the memory 30 are the same component, the recording unit 28 includes the memory 30, or the memory 30 includes the recording unit 28.

The playback module 16 is operatively connected to the input module 14 and is operatively connected to the pressure-sensing switch 24. Using the speaker 28, the playback module 16 is configured to play audio that represents the input received from a person. Specifically, the playback module 16 is configured to play the selected audio message through the speaker 28 upon activation of the pressure-sensing switch 24. The playback module 16 may include any structure, component, device, and/or the like that enables the playback module 16 to play the selected audio message, such as, but not limited to, an analog playback device, a digital playback device, a tape drive, a compact disc drive, an MP3 playback device, and/or the like. The playback module 16 may include a playback switch 40 that, upon activation thereof, causes the playback module 16 to play the selected audio message without the pressure-sensing switch 24 being activated. Optionally, the playback module 16 includes the memory 30, the processor 32, and/or the power switch 34.

The playback module 16 may play the selected audio message through the speaker 38 any number of times upon activation of the pressure-sensing switch 24. In some embodiments, the playback module 16 is configured to repeat playback of the selected audio message a predetermined number of times upon activation of the pressure-sensing switch 24, while in other embodiments the playback module 16 is configured to only play the selected audio message once upon activation of the pressure-sensing switch 24. Moreover, in some embodiments, the playback module 16 is configured to repeat playback of the selected audio message until the pressure-sensing switch 24 has been deactivated (i.e., the predetermined amount of pressure is no longer being applied to the mat body 18). The input module 14 may be configured to enable a user of the mat system 10 to select the number of times the playback module 16 plays the selected audio message and/or whether the selected audio message is repeated until the pressure-sensing switch 24 is deactivated.

Optionally, the playback module 16 is operatively connected to a door bell system (not shown) of an enclosure. When operatively connected to a door bell system, the playback module 16 may be configured to play the selected audio message using a speaker (not shown) of the door bell system and/or may be configured to activate a door bell (not shown) of the door bell system upon activation of the pressure-sensing switch 24.

Referring again to FIGS. 1 and 2, the mat system 10 may include a display (not shown) that facilitates communication between the mat system 10 and a user thereof. The display may be a component of the mat body 18, the input module 16, and/or the playback module 16. In some embodiments, the mat system 10 includes a log module (not shown) that is operatively connected to the pressure-sensing switch 24. The log module may be configured to log a variety of different variables of the mat system 10, such as, but not limited to, a time of day that the pressure-sensing switch 24 is activated, a frequency of activation of the pressure-sensing switch 24, and/or a duration that the pressure-sensing switch 24 remains activated. The log module may include memory and/or processing components for performing the various functions of the log module. For example, the log module may include the memory 30 and/or the processor 32.

The various electrical components of the mat system 10 may be configured to receive electrical power from any type of power source (not shown), such as, but not limited to, a power distribution grid, a battery, an electrical generator, and/or the like. In the exemplary embodiment, the mat system 10 includes a battery (not shown) that supplies electrical power to the various electrical components of the mat system 10. In some embodiments, the mat system 10 includes a power cord (not shown) that is configured to be plugged into a conventional wall outlet for receiving electrical power therefrom.

The mat body 18, the input module 14, the playback module 16, the pressure-sensing switch 24, the log module, and/or various components thereof may be discrete components from each other and/or may be integrated as one or more common components. For example, the mat system 10 may include a control module that includes one or more components of the mat body 18, the input module 14, the playback module 16, the pressure-sensing switch 24, and/or the log module. Moreover, and for example, one or more components of the input module 14, the playback module 16, and/or the log module may be contained within a common housing that is discrete from the mat body 18 or that is integrated with the mat body 18. In the exemplary embodiment, the input module 14 and the playback module 16 are integrated into a common housing 44 that is a discrete component from the body 18 of the mat 12. Yet another example includes integrating the speaker 38 into the mat body 18.

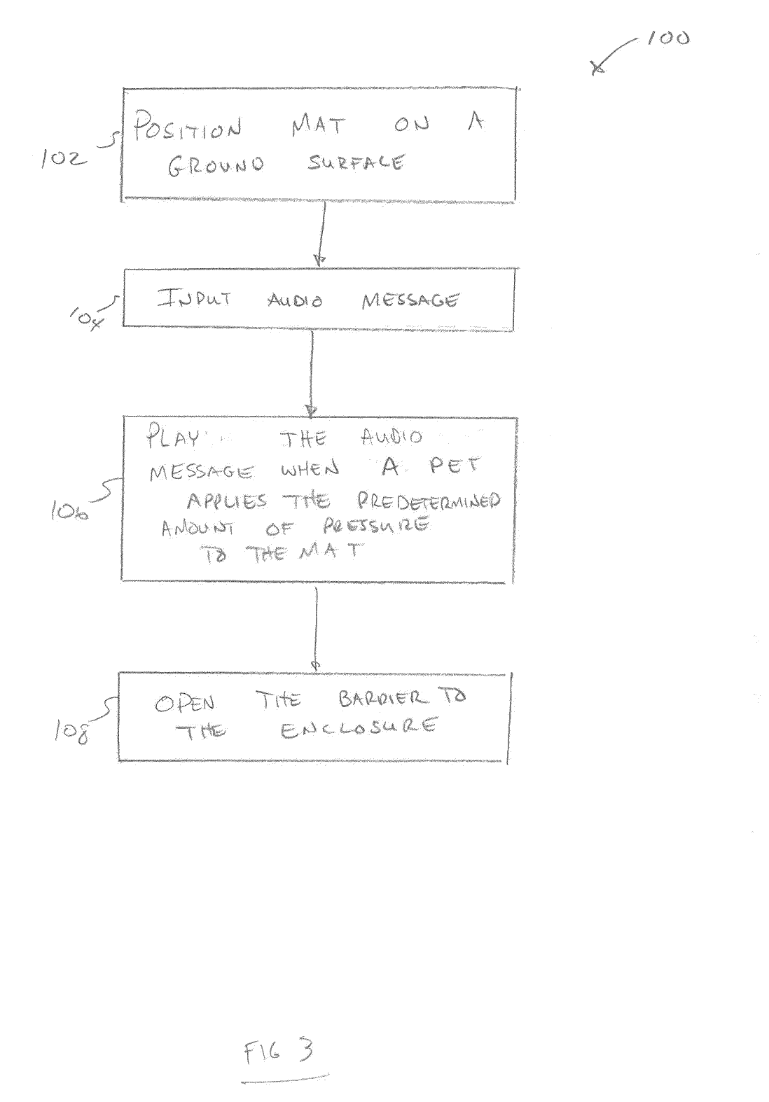

FIG. 3 is a flowchart illustrating an exemplary embodiment of a method 100 of using the mat system 10. The mat system 10 may be used, for example, to enable a pet to enter and/or exit an enclosure through a barrier. The pet may be any type of pet, such as, but not limited to, a dog, a cat, a bird, a hamster, a pig, a reptile, and/or the like. The enclosure may be any type of enclosure, such as, but not limited to, a home, an apartment, a garage, a dwelling, a tent, a cabin, a mobile home, a pet house, a dorm room, a hotel, a motel, a warehouse, a business, and/or the like. The barrier may be any barrier to exit and/or entry of the enclosure, such as, but not limited to, a door, a window, a pet door, and/or the like.

The method 100 includes positioning 102 the mat 12 on a ground surface such that the side 20 of the mat 12 is exposed for receiving at least a portion of a pet thereon. The mat 12 may be positioned 102 on any ground surface wherein playing of the selected audio message indicates that the pet desires to enter and/or exit the enclosure. The mat 12 may be positioned 102 at a location that is adjacent the barrier, or may be positioned 102 at a location that is remote from the barrier. The mat 12 may be positioned 102 inside the enclosure or outside the enclosure.

At 104, the method 100 includes inputting an audio message using the input module 14. In other words, a user of the mat system 10 selects the audio message that will be played by the playback module 16 upon activation of the pressure-sensing switch 24. As described above, inputting 104 the audio message may include speaking the audio message into the microphone 26, composing the audio message, and/or selecting the audio message from a menu and/or a list.

At 106, the method 100 includes playing the audio message when a pet applies the predetermined amount of pressure to the mat body 18. In other words, the method 100 includes playing 106 the selected audio message upon activation of the pressure-sensing switch 24. The playback 106 of the selected audio message indicates to a person or other individual who hears the audio message that the pet desires to enter or exit the enclosure through the barrier. The method 100 thus further includes opening 108 the barrier to the enclosure in response to hearing the audio message to enable the pet to enter or exit the enclosure.

The mat system 10 and/or method 100 may be used as a convenient and effective system for indicating when a pet wants to enter or exit an enclosure. The mat system 10 and/or method 100 may also be used to train a pet to expel waste (i.e., go the bathroom, relieve themselves, etc.) outside of the dwelling. Moreover, mat system and/or method 100 may be used to train a pet owner about the bathroom and/or other habits of their pet. For example, the method 100 may include using the log module to track the time(s) of day the pet desires to exit and/or enter the enclosure, the frequency at which the pet desires to enter and/or exit the enclosure, a duration that the pet remains applying pressure to the mat 12, and/or the like. The information tracked by the log module may educate a person as to the waste and/or other habits of their pet, which may enable the pet owner to better plan ahead as to when a person will need to be at the enclosure to allow the pet to enter and/or exit the enclosure. Still further, the mat system 10 and/or the method 100 may be used to provide security to an enclosure, for example by indicating when a person or other individual is positioned outside a barrier to the enclosure.

It should be noted that the various embodiments may be implemented in hardware, software or a combination thereof. The various embodiments and/or components, for example, the modules, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as a solid state drive, optical drive, and/or the like. The storage device may also be other similar means for loading computer programs or other instructions into the computer or processor.

As used herein, the term “computer” or “module” may include any processor-based or microprocessor-based system including systems using microcontrollers, reduced instruction set computers (RISC), ASICs, logic circuits, and any other circuit or processor capable of executing the functions described herein. The above examples are exemplary only, and are thus not intended to limit in any way the definition and/or meaning of the term “computer”.

The computer or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer or processor as a processing machine to perform specific operations such as the methods and processes of the various embodiments of the invention. The set of instructions may be in the form of a software program. The software may be in various forms such as system software or application software and which may be embodied as a tangible and non-transitory computer readable medium. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

What is claimed is:

1. A mat system for a pet, the mat system comprising:
a mat comprising a pet side, the mat being configured to be positioned on a ground surface such that the pet side of the mat is exposed for receiving at least a portion of a pet thereon, the mat comprising a pressure-sensing switch configured to be activated when the pet applies a predetermined amount of pressure to the mat;
an input module configured to accept an input from a person; and
a playback module operatively connected to the input module and operatively connected to the pressure-sensing switch, the playback module being configured to play audio that represents the input, wherein the playback module is configured to play the audio that represents the input upon activation of the pressure-sensing switch.

2. The mat system of claim 1, wherein the input module comprises a microphone and a recording unit, the input including audio that is spoken by the person, the microphone being configured to accept the audio spoken by the person, the recording unit being configured to record the audio spoken by the person.

3. The mat system of claim 1, wherein the input module comprises at least one of a keyboard, a mouse, a track pad, a stylus, a pointer, a rotary knob, or a touchscreen.

4. The mat system of claim 1, wherein the input module is configured to enable the person to at least one of compose the input, select the input from a menu, or select the input from a list of at least two inputs.

5. The mat system of claim 1, wherein the predetermined amount of pressure is at least one of selected by the person, a weight threshold of a particular type of pet, or a weight threshold of a specific pet.

6. The mat system of claim 1, wherein the playback module is configured to repeat playback of the audio that represents the input until the pressure-sensing switch has been deactivated.

7. The mat system of claim 1, wherein the playback module is configured to repeat playback of the audio that represents the input a predetermined number of times upon activation of the pressure-sensing switch.

8. The mat system of claim 1, further comprising a log module operatively connected to the pressure-sensing switch, the log module being configured to track at least one of:
a time of day that the pressure-sensing switch is activated;
a frequency of activation of the pressure-sensing switch; or
a duration that the pressure-sensing switch remains activated.

9. The mat system of claim 1, wherein the playback module is operatively connected to a door bell system and is configured to at least one of:
play the audio that represents the input using a speaker of the door bell system; or
activate a door bell of the door bell system upon activation of the pressure-sensing switch.

10. The mat system of claim 1, wherein the playback module comprises a speaker, the playback module being configured to play the audio that represents the input using the speaker.

11. The mat system of claim 1, wherein the mat comprises a speaker, the playback module being configured to play the audio that represents the input using the speaker.

12. A method for enabling a pet to at least one of enter or exit an enclosure through a barrier, the method comprising:
positioning a mat on a ground surface such that a pet side of the mat is exposed for receiving at least a portion of a pet thereon;
playing a message as audio when the pet applies a predetermined amount of pressure to the mat; and
opening the barrier to the enclosure in response to the audio to enable the pet to enter or exit the enclosure.

13. The method of claim 12, wherein playing the message as audio comprises repeating playback of the audio until the pet no longer applies the predetermined amount of pressure to the mat.

14. The method of claim 12, wherein playing the message as audio comprises playing the message a predetermined number of times when the pet applies the predetermined amount of pressure to the mat.

15. The method of claim 12, wherein the predetermined amount of pressure is at least one of a weight threshold of a particular type of pet or a weight threshold of a specific pet.

16. The method of claim 12, further comprising tracking at least one of:
a time of day that the pet applies the predetermined amount of pressure to the mat;
a frequency that the pet applies the predetermined amount of pressure to the mat; or
a duration that the pet applies the predetermined amount of pressure to the mat.

17. The method of claim 12, wherein playing the message as audio comprises playing the audio using a speaker of a door bell system of the enclosure.

18. The method of claim 12, further comprising activating a door bell of the enclosure when the pet applies the predetermined amount of pressure to the mat.

19. The method of claim 12, wherein positioning the mat comprises providing the mat with a pressure-sensing switch that is configured to be activated when the pet applies a predetermined amount of pressure to the mat, and wherein playing the message comprises playing the message upon activation of the pressure-sensing switch.

20. The method of claim 12, further comprising inputting the message, wherein inputting the message comprises at least one of:
speaking the message into a microphone;
composing the message; or
selecting the message from at least one of a menu or a list.
